(19) United States
(12) Patent Application Publication
(10) Pub. No.: US 2025/0188214 A1
(43) Pub. Date: Jun. 12, 2025

(54) GRAFT COPOLYMER FOR LITHIUM SECONDARY BATTERY BINDER AND METHOD FOR PRODUCING SAME

(71) Applicants: Hyundai Motor Company, Seoul (KR); Kia Corporation, Seoul (KR); POSTECH Research and Business Development Foundation, Pohang-si (KR)

(72) Inventors: Jun Ki RHEE, Seoul (KR); Sung Ho BAN, Hwaseong-si (KR); Hui Beom NAM, Suwon-si (KR); Yong Ho LEE, Incheon (KR); Yoon Sung LEE, Suwon-si (KR); Tae Rim LEE, Hwaseong-si (KR); Jieun KANG, Pohang-si (KR); Sungho KIM, Pohang-si (KR); DongJoo KIM, Pohang-si (KR); Soojin PARK, Pohang-si (KR)

(73) Assignees: Hyundai Motor Company, Seoul (KR); Kia Corporation, Seoul (KR); POSTECH Research and Business Development Foundation, Pohang-si (KR)

(21) Appl. No.: 18/650,462

(22) Filed: Apr. 30, 2024

(30) Foreign Application Priority Data
Dec. 11, 2023 (KR) 10-2023-0178911

(51) Int. Cl. C08F 251/00; H01M 4/62

(52) U.S. Cl. CPC C08F 251/00; H01M 4/622

(57) ABSTRACT

A graft copolymer is formed by graft polymerization of a main chain containing dextran and a side chain containing N-(hydroxymethyl) acrylamide, wherein the graft copolymer is used as a binder for a lithium secondary battery anode to effectively buffer a large volume change during the charge/discharge of an anode, a silicon-based anode, improving mechanical stability, rate capability, and charge/discharge cycling stability of the anode, thus remarkably improving charge/discharge performance and cycle life characteristics of a battery using the same, and the graft copolymer can be produced through radical polymerization securing high reproducibility and simple production.

### CROSS-REFERENCE TO RELATED APPLICATION(S)

The present application claims priority to Korean Patent Application No. 10-2023-0178911, filed on Dec. 11, 2023, the entire contents of which is incorporated herein for all purposes by this reference.

### BACKGROUND OF THE PRESENT DISCLOSURE

### Field of the Present Disclosure

The present disclosure relates to a graft copolymer, which is formed by graft polymerization of a main chain containing dextran and a side chain containing N-(hydroxymethyl) acrylamide. The present disclosure also relates to a graft copolymer, which is used as a binder for a lithium secondary battery anode to effectively buffer a large volume change during the charge/discharge of an anode, especially, a silicon-based anode, improving mechanical stability, rate capability, and charge/discharge cycling stability of the anode, thus remarkably improving charge/discharge performance and cycle life characteristics of a battery using the same. The present disclosure also relates to a graft polymer, which can be produced through radical polymerization securing high reproducibility and simple production.

### Description of Related Art

Lithium secondary batteries are widely used in portable energy storage devices, electric cars, and the like due to their high energy density, low cost, long cycle life, and safety. The development of lithium-ion batteries with high energy density and long cycle life is receiving attention. Although graphite is one of the most commonly used anode materials, its low theoretical capacity serves as a factor limiting the performance of lithium-ion batteries. Silicon, which has a relatively low lithium ion intercalation potential and a high theoretical capacity (4200 mAh/g), is considered to be an anode material for next-generation lithium-ion batteries.

However, silicon anodes are not being commercialized due to enormous volume changes occurring during the charge/discharge of batteries. The volume changes occurring during the charge/discharge cause cracks in an electrode material, ultimately resulting in the collapse of the electrically conductive network formed among silicon particles, conductive carbon, and a metal-based current collector. Such deterioration of electrodes blocks the electrical contact between the silicon particles and the current collector, resulting in a rapid loss of capacity. A variety of studies are being conducted to reduce the volume change of silicon.

The information included in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a graft copolymer, which is used as a binder for a lithium secondary battery anode to effectively buffer a large volume change during the charge/discharge of an anode, especially, a silicon-based anode, improving mechanical stability, rate capability, and charge/discharge cycling stability of the anode, thus remarkably improving charge/discharge performance and cycle life characteristics of a battery using the same.

Another aspect of the present disclosure is to provide a graft polymer, which can be produced through radical polymerization securing high reproducibility and simple production.

The technical subjects of the present disclosure may not be limited to the above-mentioned technical subjects, and other technical subjects which are not mentioned may be clearly understood, through the following descriptions, by those skilled in the art.

In accordance with an aspect of the present disclosure, there is provided a graft polymer, including: a main chain containing dextran; and a side chain grafted to the main chain and containing N-(hydroxymethyl) acrylamide.

The grafting of dextran and N-(hydroxymethyl) acrylamide may be made by a covalent bond formed by reaction of a dextran radical and a N-(hydroxymethyl) acrylamide monomer.

The graft copolymer may adhere to the surface of a silicon active material through a hydrogen bond between silicon and the graft copolymer.

The weight ratio of dextran and N-(hydroxymethyl) acrylamide may be 1:0.8 to 1:1.2.

In infrared spectral analysis, a first peak may appear in the 1700 to 1750 cm⁻ region, a second peak may appear in the 1580 to 1650 cm⁻¹ region, and a third peak may appear in the 1050 to 1150 cm⁻¹ region.

In accordance with another aspect of the present disclosure, there is provided a method for producing a graft copolymer, the method including: dissolving a dextran monomer in a solvent to prepare a dextran solution; adding an N-(hydroxymethyl) acrylamide monomer to the dextran solution to prepare a graft copolymer solution; and adding a non-solvent to the graft copolymer solution to precipitate a graft copolymer, followed by drying.

The weight ratio of dextran and N-(hydroxymethyl) acrylamide may be 1:0.8 to 1:1.2.

In the preparing of the dextran solution, the solvent may be water.

The preparing of the dextran solution, the temperature of the dextran solution may be 60 to 80° C.

In the preparing of the graft copolymer solution, an initiator may be added to the dextran solution.

The initiator may be ammonium persulfate (APS).

The weight of the initiator may be 1 wt % relative to a total of 100 wt % of the N-(hydroxymethyl) acrylamide monomer.

The non-solvent may be acetone.

In accordance with yet another aspect of the present disclosure, there is provided a binder for a lithium secondary battery, wherein the binder may contain the graft copolymer of the present disclosure.

In accordance with yet another aspect of the present disclosure, there is provided an electrode for a lithium secondary battery, wherein the electrode may include the graft copolymer of the present disclosure.

The electrode may have a value of 25 gf/mm or more in an adhesion strength test (180° peel-off test).

In accordance with yet another aspect of the present disclosure, there is provided a lithium secondary battery, wherein the lithium secondary battery may include the graft copolymer of the present disclosure.

The technical subjects of the present disclosure may not be limited to the above-mentioned technical subjects, and other technical subjects which are not mentioned may be clearly understood, through the following descriptions, by those skilled in the art.

The graft copolymer of the present disclosure is formed by graft polymerization of a main chain containing dextran and a side chain containing N-(hydroxymethyl) acrylamide. The graft copolymer of the present disclosure is used as a binder for a lithium secondary battery anode to effectively buffer a large volume change during the charge/discharge of an anode, especially, a silicon-based anode, improving mechanical stability, rate capability, and charge/discharge cycling stability of the anode, thus remarkably improving charge/discharge performance and cycle life characteristics of a battery using the same.

Furthermore, the graft copolymer can be produced through radical polymerization securing high reproducibility and simple production.

Advantageous effects obtainable from the present disclosure may not be limited to the above-mentioned effects, and other effects which are not mentioned may be clearly understood, through the following descriptions, by those skilled in the art to which the present disclosure pertains.

The methods of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 schematically shows the binding of a graft copolymer of the present disclosure to an active material.

FIG. 2 shows a graft copolymer of the present disclosure.

FIG. 3 shows a reaction scheme for producing a graft copolymer of the present disclosure.

FIG. 4 is a graph showing the infrared spectroscopy spectrum of a graft copolymer according to an example of the present disclosure.

FIG. 5 shows a method for producing a graft copolymer according to an example of the present disclosure.

FIG. 6 is a graph showing the results of adhesion strength evaluation (180° peel-off test) of an electrode of Example 3.

FIG. 7 is a graph showing the results of adhesion strength evaluation (180° peel-off test) of electrodes of Comparative Examples 7, 8, 9, and 10.

FIG. 8 is a graph of electrochemical cycle life evaluation for showing Coulombic efficiency according to the charge/discharge cycle of a half-cell according to Example 4.

FIG. 9 is a graph of electrochemical cycle life evaluation showing Coulombic efficiency according to the charge/discharge cycle of a half-cell according Comparative Example 11.

FIG. 10 is a graph of electrochemical cycle life evaluation showing Coulombic efficiency according to the charge/discharge cycle of a half-cell according Comparative Example 12.

FIG. 11 is a graph of electrochemical cycle life evaluation showing Coulombic efficiency according to the charge/discharge cycle of a half-cell according Comparative Example 13.

FIG. 12 is a graph of electrochemical cycle life evaluation for showing Coulombic efficiency according to the charge/discharge cycle of a half-cell according Comparative Example 14.

FIG. 13 is a graph of electrochemical impedance performance evaluation of a half-cell according to Example 5.

FIG. 14 is a graph of electrochemical impedance performance evaluation of a half-cell according to Comparative Example 15.

FIG. 15 is a graph of electrochemical impedance performance evaluation of a half-cell according to Comparative Example 16.

FIG. 16 is a graph of electrochemical impedance performance evaluation of a half-cell according to Comparative Example 17.

FIG. 17 is a graph of electrochemical impedance performance evaluation of a half-cell according to Comparative Example 18.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Various changes and modifications may be made to the present disclosure and the present disclosure may have various exemplary embodiments of the present disclosure, and therefore various exemplary embodiments will be illustrated in the drawings and described in the specification or application. However, it should be understood that embodiments according to the concept of the present disclosure are not limited to the particular included exemplary embodiments, but the present disclosure includes all modifications, equivalents, and alternatives falling within the spirit and scope of the present disclosure.

The terms used in the present disclosure are only used to describe specific embodiments, and are not intended to limit the present disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Herein, it should be interpreted that a range of “X to Y” includes all numbers between from X to Y. For example, it should be interpreted that a range of 1 to 10 includes not only 1 and 10 but also all the numbers in between, that is, integers and prime numbers.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure.

Infrared spectroscopy analysis is an experimental method where, by exposing a molecule to light in the infrared region, the molecule is allowed to absorb light at a unique vibrational frequency required to induce coupled vibrations, measuring characteristic infrared spectra corresponding thereto. Since each bond structure between constituent elements of a molecule has a characteristic value, the bond structure between the constituent elements of the molecule can be determined by the characteristic value. Specifically, infrared spectroscopy analysis may be performed using Bruker's IR spectrometer INVENIO model. Besides the above device, any device used in the art may be appropriately employed.

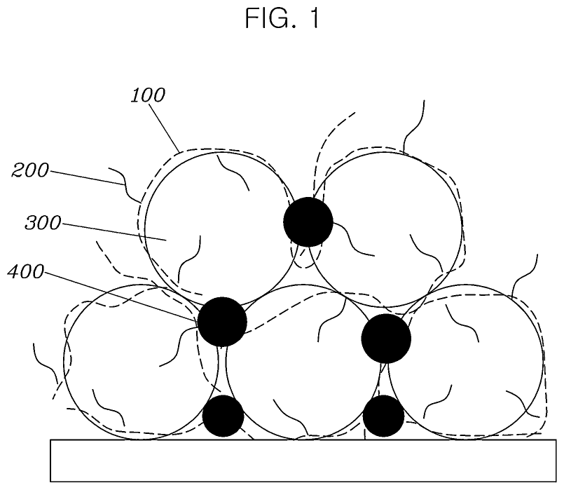

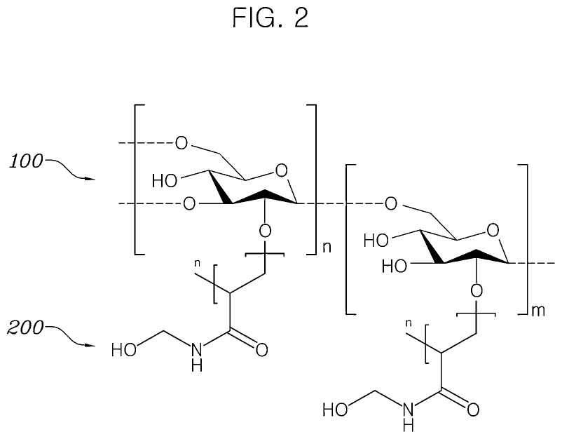

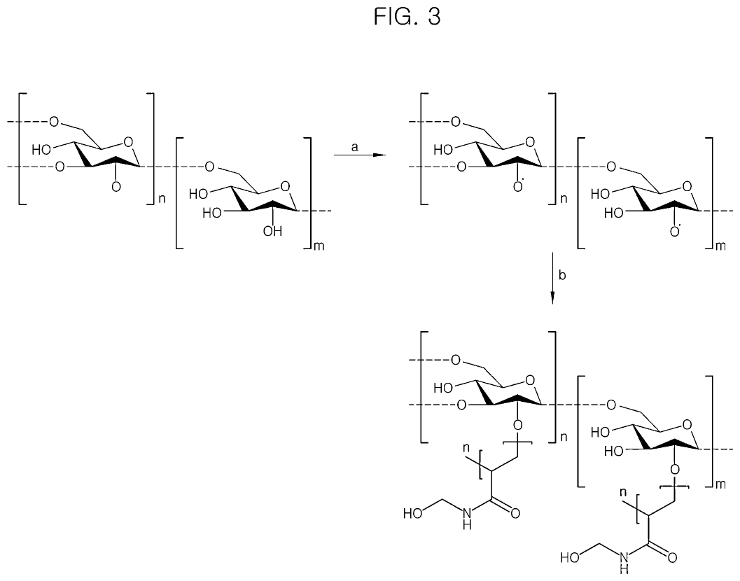

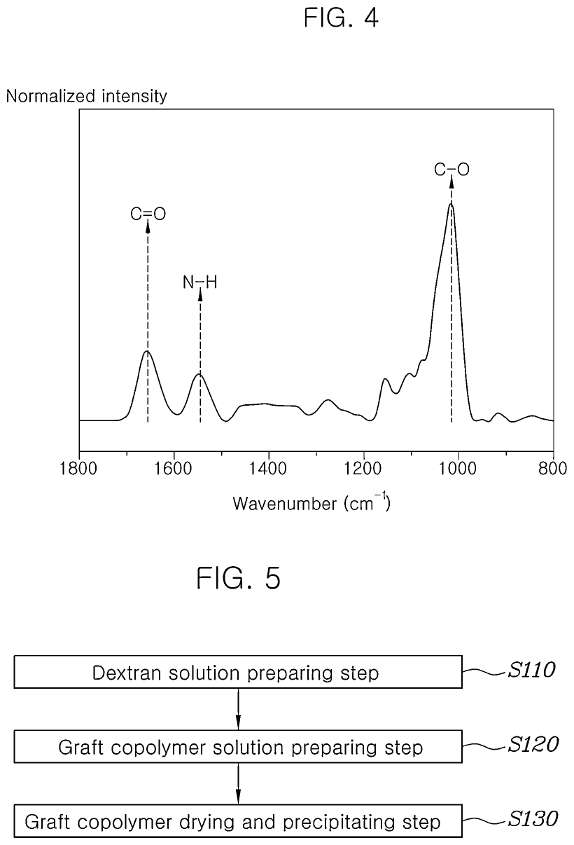

FIG. 1 schematically shows the binding of a graft copolymer of the present disclosure to an active material, FIG. 2 shows a graft copolymer of the present disclosure, FIG. 3 shows a reaction scheme for producing a graft copolymer of the present disclosure, and FIG. 4 is a graph showing the infrared spectroscopy spectrum of a graft copolymer according to an example of the present disclosure. The graft copolymer of the present disclosure will be described with reference to the drawings.

Dextran, which has excellent mechanical strength, has outstanding adhesive properties to a silicon-based anode active material with a hydrophilic surface as well as a conductive material including graphite/carbon with a hydrophobic surface, due to its structure having both a hydrophobic carbon ring and a hydrophilic hydroxyl group.

However, dextran somewhat lacks flexibility rather than rigidity and is composed of a single polymer chain, so that dextran fails to fully respond to large volume changes and internal stress of a silicon-based anode active material.

To solve these problems, a consideration can be made on a binder for a lithium secondary battery, the binder containing a graft copolymer containing: a main chain containing dextran; and a side chain containing N-(hydroxymethyl) acrylamide, the graft copolymer being formed by grafting of the side chain to the main chain.

N-(hydroxymethyl) acrylamide has excellent flexibility and hydrogen bonding-based self-healing properties. These are attributed to the elements N, O, and H present in N-(hydroxymethyl) acrylamide, and this hydrogen bonding can increase adhesion properties to a polar silicon active material, enabling more effective binding to a silicon anode active material.

In addition, N-(hydroxymethyl) acrylamide enables reversible hydrogen bonding to the surface of the silicon anode material, so that even though the binder and the silicon anode material are separated from each other by external impact, the binder can easily re-adhere to the surface of the silicon anode material.

The graft copolymer of the present disclosure containing such an N-(hydroxymethyl) acrylamide side chain can secure all of adhesive properties, flexibility, and self-healing properties, and through such properties, the graft copolymer is used as a binder for a silicon anode for a lithium-ion battery that undergoes a severe volume change during intercalation/de-intercalation of lithium ions in a lithium secondary battery, reducing the volume change of silicon-carbon composite-based anode active material and exhibiting excellent electrochemical performance.

As shown in FIG. 2, the graft copolymer of the present disclosure may be formed by grafting, that is, cross-linking of a main chain 100 containing dextran and a side chain 200 grafted to the main chain and containing N-(hydroxymethyl) acrylamide.

As shown in FIG. 1, the graft copolymer can bind an active material 300 and a conductive material 400 to an electrode plate.

In addition, the graft copolymer can adhere to the surface of the silicon active material through a hydrogen bond between silicon and the graft copolymer.

The weight ratio of dextran and N-(hydroxymethyl) acrylamide in the graft copolymer may be 1:0.5 to 1:2, preferably 1:0.8 to 1:1.2. As can be seen from the examples to be described later, the graft copolymer satisfying the above range can reduce the volume changes of the silicon anode active material and exhibit excellent electrochemical performance.

The N-(hydroxymethyl) acrylamide-based polymer may be poly(N-(hydroxymethyl) acrylamide).

As shown in FIG. 3, the grafting of dextran and N-(hydroxymethyl) acrylamide may be made by a covalent bond formed by reaction of a dextran radical and an N-(hydroxymethyl) acrylamide monomer.

The dextran-poly(N-(hydroxymethyl) acrylamide) graft copolymer of the present disclosure may be formed by: (a) adding ammonium persulfate ((NH₄) S₂O₈) to dextran to form an activated dextran radical; and (b) allowing the added N-(hydroxymethyl) acrylamide monomer reacts with the activated dextran radical (b).

As shown in FIG. 4, the infrared spectrum analysis of the graft copolymer of the present disclosure may show peaks attributed to the C═O double bond, the N—H single bond, and the C—O single bond.

Specifically, the first peak may appear at 1700-1750 cm⁻¹ due to the stretching vibration of the C═O double bond, the second peak may appear at 1580-1650 cm⁻¹ due to the bending vibration of the N—H single bond, and the third peak may appear at 1050-1150 cm⁻¹ due to the stretching vibration of the C—O single bond.

FIG. 5 shows a method for producing a graft copolymer according to an example of the present disclosure. A method for producing the graft copolymer of the present disclosure will be described with reference to the drawing.

Since the graft copolymer of the present disclosure is produced by radical polymerization, the preparation process is very simple and highly reproducible.

First, the method may include a step of dissolving a dextran monomer in a solvent to prepare a dextran solution (S110).

Dextran may be solved in a solvent.

About 5 wt % of dextran may be dissolved relative to a total of 100 wt % of the solvent.

Particularly, the solvent may be a polar solvent and thus water. Through the use of water, a solvent easily available in the art, the process can be easily prepared and a low cost can be secured.

In addition, the temperature of the dextran solution may be maintained at 60-80° C., preferably 70° C. Therefore, the temperature of the process can be kept relatively low and the cost of the process equipment can be reduced.

The method may include a step of adding an N-(hydroxymethyl) acrylamide monomer to the dextran solution to prepare a graft copolymer solution (S120).

An initiator may be added to the dextran solution with dextran dissolved therein. Particularly, the initiator may be ammonium persulfate (APS). About 1 wt % of the initiator may be dropped into the dextran solution relative to a total of 100 wt % of an N-(hydroxymethyl) acrylamide monomer to be described later.

The temperature of the dextran solution may be maintained at 60-80° C., preferably 70° C.

The N-(hydroxymethyl) acrylamide monomer may be dropped into the dextran solution.

The weight ratio of dextran and N-(hydroxymethyl) acrylamide in the graft copolymer may be 1:0.5 to 1:2, preferably 1:0.8 to 1:1.2. As can be confirmed in the examples to be described later, an anode for a lithium secondary battery using a graft copolymer satisfying the above range resulted in the superior battery performance.

The method may include a step of adding a non-solvent to the graft copolymer solution to precipitate a graft copolymer, followed by drying (S130).

The non-solvent is added to the solution in which the graft copolymer has been prepared and dissolved, precipitating a graft copolymer polymer. The non-solvent may be acetone.

Subsequently, the precipitated graft copolymer polymer may be dried.

Hereinafter, excellent effects of the present disclosure will be described by comparing examples and comparative examples of the graft copolymer of the present disclosure.

In the method for producing a graft copolymer according to an exemplary embodiment of the present disclosure, graft copolymers were produced under various conditions of the production method, and silicon-based anodes were prepared by use of the graft copolymers as binders, respectively.

The silicon-based anodes of the graft copolymer based on the examples and comparative examples were subjected to a peel-off test, and the prepared silicon-based anodes were used to manufacture coin cells, which were then measured for electrochemical performance.

### Material Preparation

### Example 1

About 5 wt % of dextran was dissolved in water.

Ammonium persulfate (APS) was dropped into the solution with dextran dissolved therein. The amount of APS was 1 wt % relative to the weight of N-(hydroxymethyl) acrylamide monomer to be added later. The temperature was maintained at 70° C. (step b).

An N-(hydroxymethyl) acrylamide monomer having the same weight as dextran was dropped into the solution (step c). That is, the weight ratio of dextran and N-(hydroxymethyl) acrylamide was 1:1.

The synthesized polymer was precipitated using the non-solvent acetone and then dried (step d). Infrared spectroscopy was used to determine whether synthesis had occurred or not (step e).

### [Comparative Example 1]: Material Preparation Process

A polymer was prepared by the same method as in Example 1 except that the weight of the N-(hydroxymethyl) acrylamide monomer in step c was increased to 2 times. That is, the weight ratio of dextran and N-(hydroxymethyl) acrylamide was 1:2. The weight of APS in step b was changed according to the weight of the N-(hydroxymethyl) acrylamide monomer.

### [Comparative Example 2]: Material Preparation Process

A polymer was prepared by the same method as in Example 1 except that the weight of the N-(hydroxymethyl) acrylamide monomer in step c was reduced to 0.5 times. That is, the weight ratio of dextran and N-(hydroxymethyl) acrylamide was 1:0.5. The weight of APS in step b was changed according to the weight of the N-(hydroxymethyl) acrylamide monomer.

### Electrode Preparation

### Example 2

The polymer powder obtained in Example 1 was again dissolved in water and then used as an aqueous binder. The binder was mixed with a silicon-carbon composite active material and a conductive material to prepare a slurry, which was then cast onto a current collector to prepare an electrode.

The binder synthesized according to an exemplary embodiment of the present disclosure and styrene butadiene rubber (SBR) were used at a weight ratio of 1:1.

The prepared electrode was dried at room temperature for one day, followed by pressing and subsequent secondary high-temperature vacuum drying.

### [Comparative Example 3]: Electrode Preparation

An electrode was prepared by the same method as in Example 2 except that the polymer of Comparative Example 1 containing dextran and N-(hydroxymethyl) acrylamide at a weight ratio of 1:2 was used as a binder.

### [Comparative Example 4]: Electrode Preparation

An electrode was prepared by the same method as in Example 2 except that the polymer of Comparative Example 2 containing dextran and N-(hydroxymethyl) acrylamide at a weight ratio of 1:0.5 was used as a binder.

### [Comparative Example 5]: Electrode Preparation

An electrode was prepared by the same method as in Example 2 except that dextran alone was used as a binder.

### [Comparative Example 6]: Electrode Preparation

An electrode was prepared by the same method as in Example 2 except that polyacrylic acid was used as a binder.

Mechanical property evaluation-Evaluation of electrode adhesion strength (180° peel-off test)

### [Example 3]: Mechanical Property Evaluation

The electrode prepared in Example 2 was evaluated for adhesion strength (180° peel-off test).

### [Comparative Example 7]: Mechanical Property Evaluation

The evaluation was performed in the same manner as in Example 3 except that the electrode of Comparative Example 3 containing dextran and N-(hydroxymethyl) acrylamide at a weight ratio of 1:2 was evaluated.

### [Comparative Example 8]: Mechanical Property Evaluation

The evaluation was performed in the same manner as in Example 3 except that the electrode of Comparative Example 4 containing dextran and N-(hydroxymethyl) acrylamide at a weight ratio of 1:0.5 was evaluated.

### [Comparative Example 9]: Mechanical Property Evaluation

The evaluation was performed in the same manner as in Example 3 except that the electrode of Comparative Example 5 using dextran alone was evaluated.

### [Comparative Example 10]: Mechanical Property Evaluation

The evaluation was performed in the same manner as in Example 3 except that the electrode of Comparative Example 6 using polyacrylic acid was evaluated.

TABLE 1

| | Adhesion |
|---|---|
| | strength |
| | (gf/mm) |
| Example 3 | 25.4 |
| Comparative Example 7 | 25.5 |
| Comparative Example 8 | 23.0 |
| Comparative Example 9 | 8.9 |
| Comparative Example 10 | 4.9 |

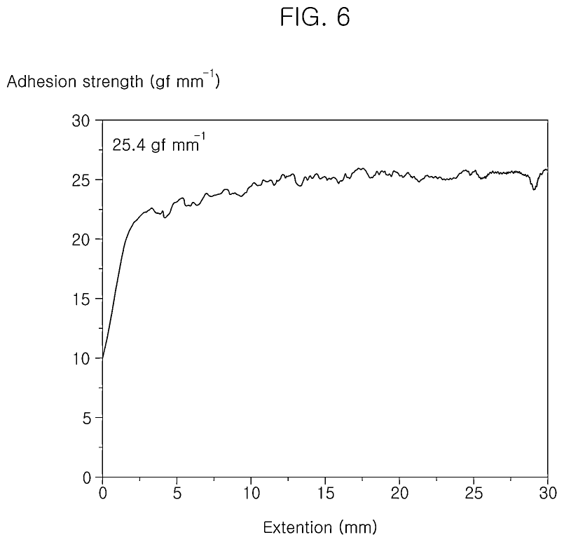

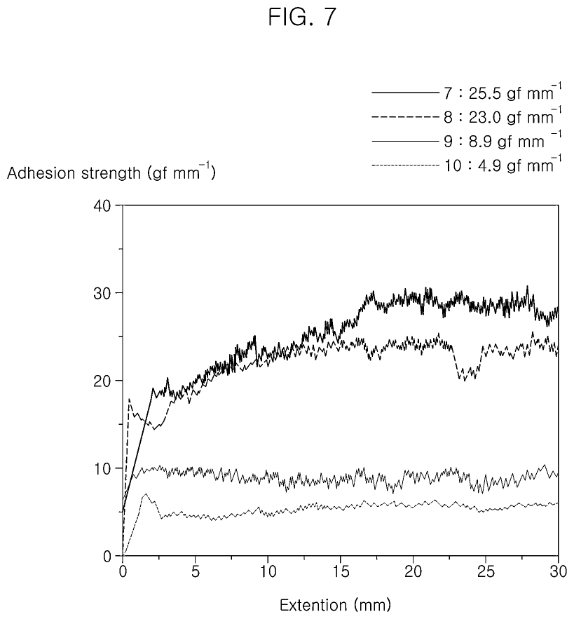

FIG. 6 is a graph showing the results of adhesion strength evaluation (180° peel-off test) of an electrode of Example 3, FIG. 7 is a graph showing the results of adhesion strength evaluation (180° peel-off test) of electrodes, and Table 1 shows the adhesion strength evaluation values of the electrodes.

Referring to FIG. 6 and FIG. 7 and Table 1, Example 3 containing dextran and N-(hydroxymethyl) acrylamide at a weight ratio of 1:1 showed an adhesion strength of 25.4 gf/mm, Comparative Example 7 containing dextran and N-(hydroxymethyl) acrylamide at a weight ratio of 1:2 showed an adhesion strength of 25.5 gf/mm, and Comparative Example 8 containing dextran and N-(hydroxymethyl) acrylamide at a weight ratio of 1:0.5 showed an adhesion strength of 230 gf/mm, and these measurement values were as high as 20.0 gf/mm or higher. However, Comparative Example 9 using dextran alone showed an adhesion strength of 8.9 gf/mm, and Comparative Example 10 using polyacrylic acid showed an adhesion strength of 4.9 gf/mm, and these measurement values were significantly lower than that obtained when the graft copolymer of the present disclosure was used.

These results confirmed that the graft copolymer of the present disclosure had excellent binding performance and an electrode for a lithium secondary battery containing the graft copolymer had excellent electrode adhesion strength.

### Electrochemical Cycle Life Evaluation

### [Example 4]: Half-Cell Manufacturing

A coin cell-type half-cell was manufactured with the electrode prepared in Example 2 as a working electrode and lithium metal disks as a counter electrode and a reference electrode. Polypropylene (PP) was used as a separator, and 1 M LiPF6 in EC: DEC (7:3) was used as a liquid electrolyte.

To evaluate the long-term cycling performance during the charge/discharge cycle process, electrodes with a mass loading level controlled to 7 mg/cm² were subjected to initial formation cycles (3 cycles) at a voltage range of 0.005-1.5 V (1 cycle: 0.05 C discharge, 0.02 C constant voltage, 0.1 C charge; and 2 cycles: 0.1 C discharge, 0.02 C constant voltage, 0.1 C charge). During the subsequent cycles, charge/discharge was conducted at a current densities of 0.2 C (discharge), 0.02 C (constant voltage), and 0.5 C (charging).

### [Comparative Example 11]: Half-Cell Manufacturing

The evaluation was performed in the same manner as in Example 4 except that the electrode of Comparative Example 3 containing dextran and N-(hydroxymethyl) acrylamide at a weight ratio of 1:2 was used as a working electrode.

### [Comparative Example 12]: Half-Cell Manufacturing

The evaluation was performed in the same manner as in Example 4 except that the electrode of Comparative Example 4 containing dextran and N-(hydroxymethyl) acrylamide at a weight ratio of 1:0.5 was used as a working electrode.

### [Comparative Example 13]: Half-Cell Manufacturing

The evaluation was performed in the same manner as in Example 4 except that the electrode of Comparative Example 5 using dextran alone was used as a working electrode.

### [Comparative Example 14]: Half-Cell Manufacturing

The evaluation was performed in the same manner as in Example 4 except that the electrode of Comparative Example 6 using polyacrylic acid was used as a working electrode.

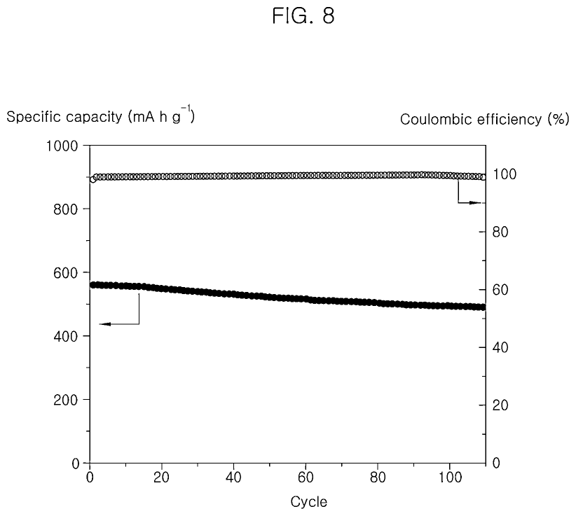

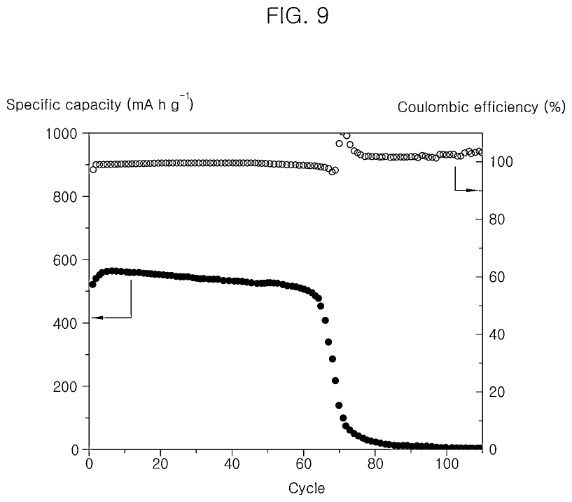

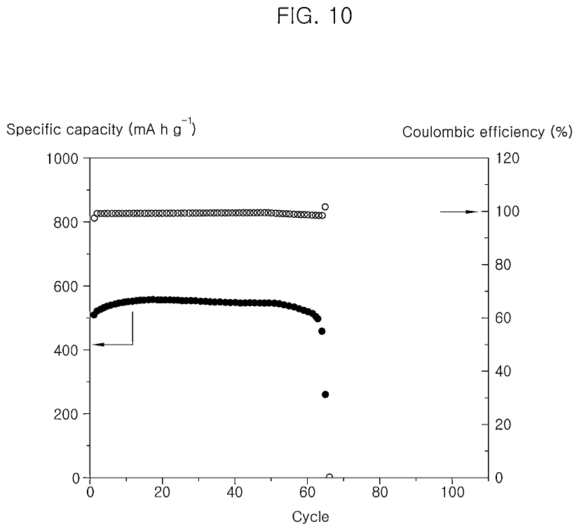

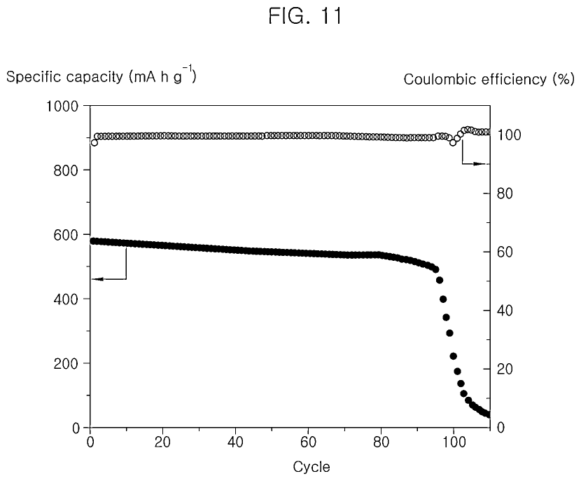

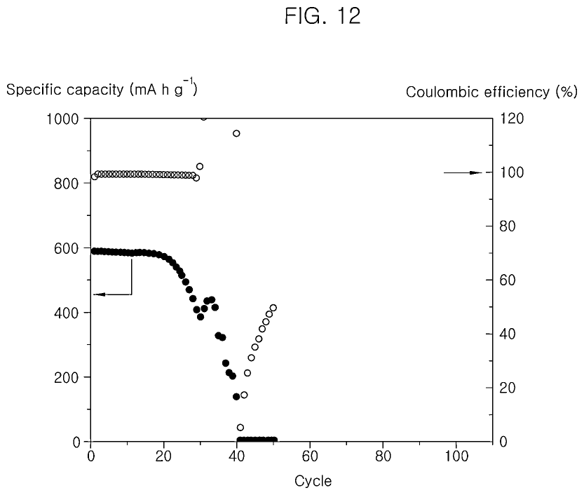

FIG. 8, FIG. 9, FIG. 10, FIG. 11 and FIG. 12 are graphs of electrochemical cycle life evaluation for half-cells of Example 4 and Comparative Examples 11 to 14. Referring to FIG. 8, Example 4 containing dextran and N-(hydroxymethyl) acrylamide at a weight ratio of 1:1 showed a consistent Coulombic efficiency and a gradual decrease in specific capacity throughout 100 or more charge/discharge cycle, leading to excellent cycling performance.

However, referring to FIG. 9, Comparative Example 11 containing dextran and N-(hydroxymethyl) acrylamide at a weight ratio of 1:2 showed a rapid change in Coulombic efficiency and a rapid decrease in specific capacity after 60 or more charge/discharge cycles, leading to poor cycling performance after 60 or more charge/discharge cycles.

Referring to FIG. 10, Comparative Example 12 containing dextran and N-(hydroxymethyl) acrylamide at a weight ratio of 1:0.5 showed a rapid change in Coulombic efficiency and a rapid decrease in specific capacity after 60 or more charge/discharge cycles, leading to poor cycling performance after 60 or more charge/discharge cycles.

Referring to FIG. 11, Comparative Example 13 using dextran alone showed a rapid change in Coulombic efficiency and a rapid decrease in specific capacity, when charge/discharge cycles proceeded almost 100 times, leading to slightly poor cycling performance.

Referring to FIG. 12, Comparative Example 14 using polyacrylic acid showed a rapid change in Coulombic efficiency and a rapid decrease in specific capacity, when the charge/discharge cycles proceeded 20 times or more. At 500 or more cycles, electrode separation occurred and thus the half-cell was destroyed, and thus further measurement could not be made. Comparative Example 14 showed poor cycling performance at 20 or more consecutive charge/discharge cycles.

These results confirmed that the graft copolymer of the present disclosure had excellent binding performance and lithium secondary battery containing the grafter copolymer had excellent Coulombic efficiency.

### Electrochemical Impedance Performance Evaluation

### [Example 5]: Electrochemical Impedance Performance Evaluation

The half-cell obtained in Example 4 was measured for resistances before the first cycle, after the first cycle, and after 50 cycles through electrochemical impedance spectroscopy (EIS). The EIS measurement was made in the same charge/discharge condition process and frequency range.

### [Comparative Example 15]: Electrochemical Impedance Performance Evaluation

The evaluation was performed in the same manner as in Example 5 except that the half-cell of Comparative Example 11 containing dextran and N-(hydroxymethyl) acrylamide at a weight ratio of 1:2 was used.

### [Comparative Example 16]: Electrochemical Impedance Performance Evaluation

The evaluation was performed in the same manner as in Example 5 except that the half-cell of Comparative Example 12 containing dextran and N-(hydroxymethyl) acrylamide at a weight ratio of 1:0.5 was used.

### [Comparative Example 17]: Electrochemical Impedance Performance Evaluation

The evaluation was performed in the same manner as in Example 5 except that the half-cell of Comparative Example 13 using dextran alone was used.

### [Comparative Example 18]: Electrochemical Impedance Performance Evaluation

The evaluation was performed in the same manner as in Example 5 except that the half-cell of Comparative Example 14 using polyacrylic acid alone was used.

TABLE 2

| | R_{SEI} + R^{ct} (Ω) | | |
|---|---|---|---|
| | Before | After | After |
| Binder | precycle | precycle | 50 cycles |
| Example 5 | 110 | 16 | 18 |
| Comparative | 136 | 23 | 537 |
| Example 15 | | | |
| Comparative | 136 | 25 | 232 |
| Example 16 | | | |
| Comparative | 127 | 23 | 18 |
| Example 17 | | | |
| Comparative | 183 | 14 | — |
| Example 18 | | | |

R_{SEI}+R_{ct} represents the resistance of a half-cell. The unit is Q.

In Comparative Example 18 using polyacrylic acid alone, electrode separation occurred and thus the half-cell was completely destroyed, after 40 charge/discharge cycles, so that the data measurement was impossible after 50 charge/discharge cycles.

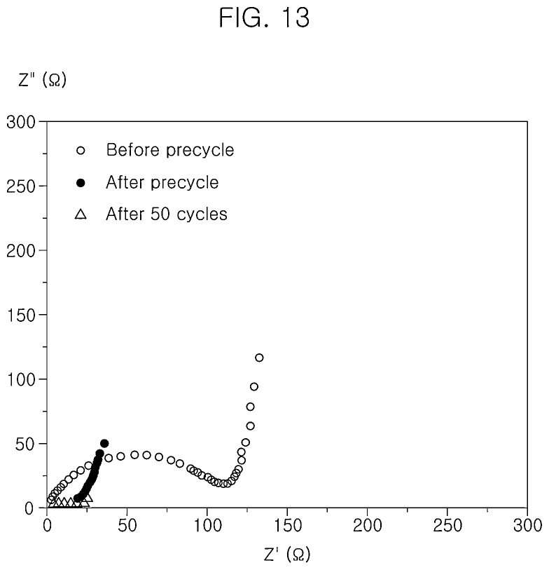

FIGS. 13 to 17 are graphs of electrochemical impedance performance evaluation of half-cells according to Example 5 and Comparative Examples 15 to 18, and Table 2 shows the resistances of the half-cells according to Example 5 and Comparative Examples 15 to 18.

Referring to FIG. 13 and Table 1, Example 5 containing dextran and N-(hydroxymethyl) acrylamide at a weight ratio of 1:1 showed 16Ω after the precycle and 18Ω after 50 repetitive charge/discharge cycles, indicating a constant low resistance value maintained even after 50 repetitive charge/discharge cycles.

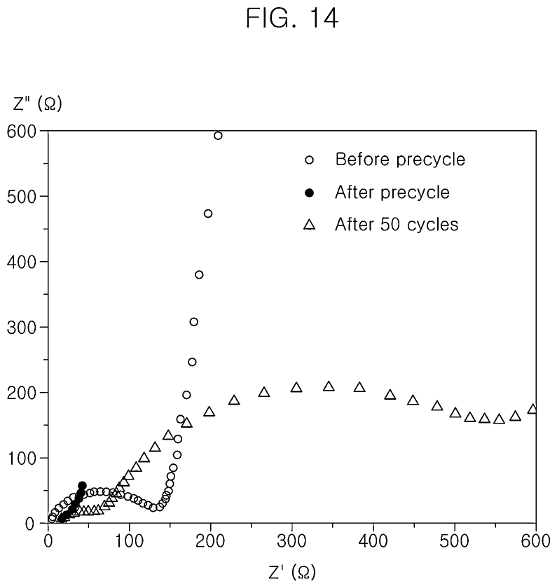

Referring to FIG. 14 and Table 1, Comparative Example 15 containing dextran and N-(hydroxymethyl) acrylamide at a weight ratio of 1:2 showed 23Ω after the precycle and 537Ω after 50 repetitive charge/discharge cycles, indicating a rapid increase in resistance value after 50 repetitive charge/discharge cycles.

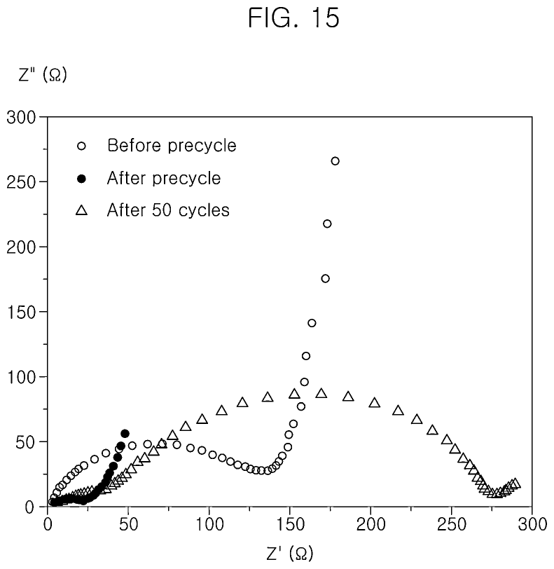

Referring to FIG. 15 and Table 1, Comparative Example 16 containing dextran and N-(hydroxymethyl) acrylamide at a weight ratio of 1:0.5 showed 25Ω after the precycle and 232Ω after 50 repetitive charge/discharge cycles, indicating a rapid increase in resistance value after 50 repetitive charge/discharge cycles.

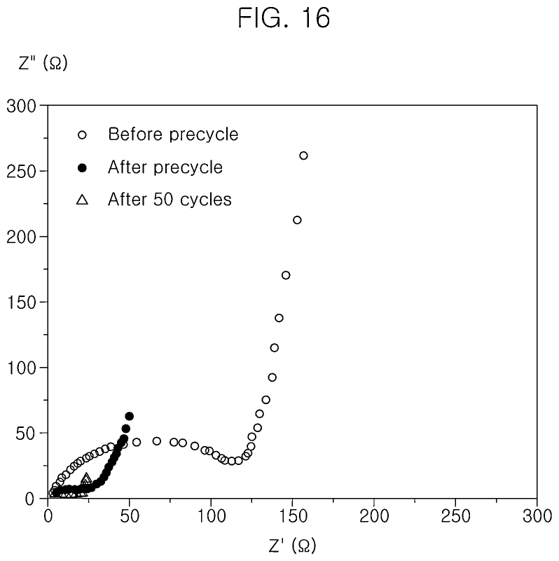

Referring to FIG. 16 and Table 1, in Comparative Example 17 using dextran alone, the resistance value was 14Ω after the precycle, but after 40 charge/discharge cycles, complete electrode separation occurred and thus the half-cell was destroyed, so that the resistance measurement was impossible after 50 repetitive charge/discharge cycles.

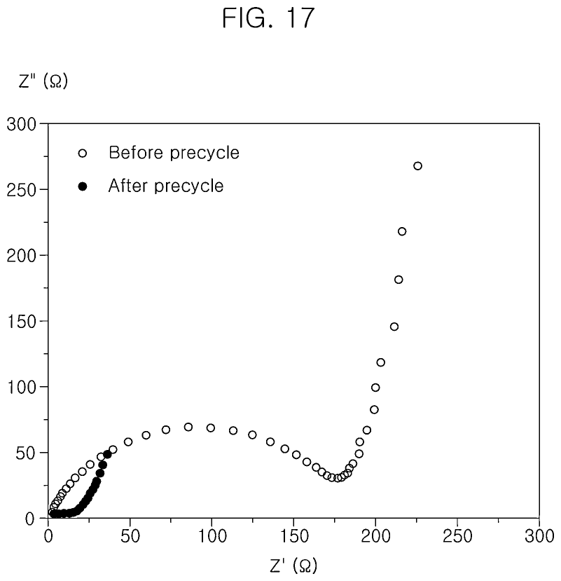

Referring to FIG. 17, in Comparative Example 18 using polyacrylic acid alone, after 40 charge/discharge cycles, complete electrode separation occurred and thus the half-cell was destroyed.

These results confirmed that the graft copolymers of the present disclosure had excellent binding performance, leading to excellent stability even after repetitive discharge/discharge cycles.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. A graft copolymer comprising:
a main chain containing dextran; and
a side chain grafted to the main chain and containing N-(hydroxymethyl) acrylamide.

2. The graft copolymer of claim 1, wherein the grafting of the dextran and the N-(hydroxymethyl) acrylamide is made by a covalent bond formed by reaction of a dextran radical and an N-(hydroxymethyl) acrylamide monomer.

3. The graft copolymer of claim 1, wherein the graft copolymer adheres to a surface of a silicon active material through a hydrogen bond between silicon and the graft copolymer.

4. The graft copolymer of claim 1, wherein a weight ratio of the dextran and the N-(hydroxymethyl) acrylamide is 1:0.8 to 1:1.2.

5. The graft copolymer of claim 1, wherein in an infrared spectral analysis, a first peak appears in 1700 to 1750 cm⁻¹ region, a second peak appears in 1580 to 1650 cm⁻¹ region, and a third peak appears in 1050 to 1150 cm⁻¹ region.

6. A method for producing a graft copolymer, the method comprising:
dissolving a dextran monomer in a solvent to prepare a dextran solution;
adding an N-(hydroxymethyl) acrylamide monomer to the dextran solution to prepare a graft copolymer solution; and
adding a non-solvent to the graft copolymer solution to precipitate the graft copolymer, followed by drying.

7. The method of claim 6, wherein a weight ratio of dextran and N-(hydroxymethyl) acrylamide is 1:0.8 to 1:1.2.

8. The method of claim 6, wherein in the preparing of the dextran solution, the solvent is water.

9. The method of claim 6, wherein in the preparing of the dextran solution, a temperature of the dextran solution is 60 to 80° C.

10. The method of claim 6, wherein in the preparing of the graft copolymer solution, an initiator is added to the dextran solution.

11. The method of claim 10, wherein the initiator is ammonium persulfate (APS).

12. The method of claim 10, wherein a weight of the initiator is 1 wt % relative to a total of 100 wt % of the N-(hydroxymethyl) acrylamide monomer.

13. The method of claim 6, wherein in the precipitating of the graft copolymer, followed by the drying, the non-solvent is acetone.

14. A binder for a lithium secondary battery, the binder comprising the graft copolymer of claim 1.

15. An electrode for a lithium secondary battery, the electrode comprising the graft copolymer of claim 1.

16. The electrode of claim 15, wherein the electrode has a value of 25 gf/mm or more in an adhesion strength test (180° peel-off test).

17. A lithium secondary battery comprising the graft copolymer of claim 1.
